(19) United States
(12) Patent Application Publication
(10) Pub. No.: US 2009/0070880 A1
(43) Pub. Date: Mar. 12, 2009

(54) METHODS AND APPARATUS FOR VALIDATING NETWORK ALARMS

(76) Inventors: David E. Harris, Addison, TX (US); Robert T. Fudge, Caddo Mills, TX (US)

Correspondence Address: THE LAW OFFICE OF PATRICK B. LAW, 912 N. DUNTON AVE., ARLINGTON, IL, 60004, US

(21) Appl. No.: 11/853,710

(22) Filed: Sep. 11, 2007

(51) Int. Cl. G08B 23/00

(52) U.S. Cl. 726/25

(57) ABSTRACT

Methods and apparatus for validating network alarms, such as alarms from an Intrusion Detection System (IDS). The methods and apparatus validate network threats or alarms by receiving a detected network alarm indicating potentially harmful network activity where the alarm including an alarm destination and an alarm type and obtaining port information of a host targeted by the alarm based on the alarm destination and alarm type. Additionally, a determination is made whether the port at the host is vulnerable to the network alarm based on the obtained port information and the alarm type, and a priority value is assigned to the alarm based at least on the determination of whether the port is vulnerable to the particular network alarm in order to assess validity of the network threat that has triggered the alarm.

### BACKGROUND

1. Field

The present disclosure relates generally to methods and apparatus for validating network alarms, and more particularly to validating network alarms through determining port information of a network destination targeted by the threat triggering the alarm.

2. Background

Network security systems, such as network Intrusion Detection Systems (IDS) or Intrusion Protection (or Prevention) Systems (IPS), monitor computer network traffic for potentially harmful or unauthorized activity or threats occurring within the network and create alarms alerting an agent device or security personnel of this activity based on a set of rules. These sets of rules are either a default set of rules extant in an IDS, or a set of rules specifically established by a network administrator.

Typical IDS systems will generate a large number of alarms when sensed network activity fires on rule signatures of the sets of rules. Typical IDS systems, however, may trigger alarms for activity that is not necessarily harmful or unauthorized, even though the rule signature warrants an alert. Triggered alarms that are not necessarily harmful or unauthorized, as commonly referred to as “False Positives”. In particular, the term “False Positive” connotes finding that the alarm, during a validation or verification check, is not harmful to a network or a destination address. Alarms normally contain the originating Internet Protocol (IP) or source address, and the destination IP or destination address. Upon investigation by security personnel, however, it may be found that the destination address within the network is not vulnerable to the threat which triggered an alarm by the IDS system. Therefore, the alarm will be tagged as “False Positive”.

Although most known IDS's incorporate mechanisms for dealing with large alarm counts, such systems typically do not possess functionality to be able to verify or validate the alarms. Therefore, in order to ensure the security of the protected network, security personnel normally have to examine each alarm, determine its validity, and then act accordingly. Even in a small network, however, this process can be very time consuming. As a result, it is known to incorporate alarm verification or validation in IDS system to attempt to mitigate the work required of security personnel in verifying alarms.

In some known systems, automated verification of alarms is accomplished by looking at a previous scan of the network to determine the vulnerability of destination addresses on the network to the signature identification of the alarm. Such static systems, however, do not allow real time analysis, which may result in an alarm being designated a “false positive” when, in fact, it is a real threat due to changed conditions on the network since the previous scan. Other known systems, which are dynamic, nonetheless may also incorrectly categorize the real nature alarms since such known systems only examiner a fingerprint of an operating system (OS) of a destination internet protocol (IP) address, for example. Merely obtaining the OS fingerprint of an IP address, however, may be ineffective or insufficient to determine if a particular port is actually susceptible to the alarmed threat, thus resulting in still too many false positives issued.

### SUMMARY

According to an aspect, a method for validating network alarms detected on a network is disclosed. The method includes receiving a detected network alarm indicating potentially harmful network activity, where the alarm includes an alarm destination and an alarm type. The method further includes obtaining port information of a host targeted by the alarm based on the alarm destination and alarm type, and then determining whether the port at the host is vulnerable to the network alarm based on the obtained port information and the alarm type. Finally, the method includes assigning a priority value to the alarm based at least on the determination of whether the port is vulnerable to the particular network alarm in order to assess validity of the network alarm.

According to another aspect, a computer program product comprising computer-readable medium is disclosed. The computer readable medium includes code for causing a computer to receive a detected network alarm indicating potentially harmful network activity, the alarm including an alarm destination and an alarm type. The medium further includes code for causing a computer to obtain port information of a host targeted by the alarm based on the alarm destination and alarm type, and code for causing a computer to determine whether the port at the host is vulnerable to the network alarm based on the obtained port information and the alarm type. Additionally, the medium includes code for causing a computer to assign a priority value to the alarm based at least on the determination of whether the port is vulnerable to the particular network alarm in order to assess validity of the network alarm.

According to still another aspect, an apparatus for use with an intrusion detection system is disclosed. The apparatus includes a receiving module configured to receive a detected network alarm from at least one intrusion detection sensor a detected network alarm indicating potentially harmful network activity, the alarm including an alarm destination and an alarm type. The apparatus further includes a port checking module configured to obtain port information of a host targeted by the alarm based on the alarm destination and alarm type and determine whether the port at the host is vulnerable to the network alarm based on the obtained port information and the alarm type. Moreover, the apparatus includes a scoring module configured to assign a priority value to the alarm based at least on the determination of whether the port is vulnerable to the particular network alarm in order to assess validity of the network alarm.

According to yet one other aspect, an intrusion detection system is disclosed. The system includes a sensor configured to sense potentially harmful activity on a network and to indicate an alarm when the potentially harmful activity is sensed, and a validation unit configured to validate whether the alarm is a valid alarm. Furthermore, the validation unit includes a receiving module configured to receive a detected network alarm from at least one intrusion detection sensor a detected network alarm indicating potentially harmful network activity, the alarm including an alarm destination and an alarm type. The validation unit also includes a port checking module configured to obtain port information of a host targeted by the alarm based on the alarm destination and alarm type and determine whether the port at the host is vulnerable to the network alarm based on the obtained port information and the alarm type. Finally, the validation unit includes a scoring module configured to assign a priority value to the alarm based at least on the determination of whether the port is vulnerable to the particular network alarm in order to assess validity of the network alarm.

### BRIEF DESCRIPTION OF THE DRAWINGS

FIG. 1 is a block diagram of an exemplary network employing a network protection system according to the present disclosure.

FIG. 2 illustrates an exemplary method for validating alarms for use in a network intrusion detection system.

FIG. 3 illustrates another apparatus for validating alarms for use in a network intrusion detection system.

FIG. 4 is an apparatus for validating alarms that is as at least part of a network intrusion detection system.

### DETAILED DESCRIPTION

The present application discloses apparatus and methods for validating alarms in a network protection system. In particular, the present apparatus and methods perform real-time analysis of alarms to determine if the destination port for each alarm on the network is actually vulnerable to the alarm type prior to the alarm being stored in a database of alarms, which is accessed by security personnel. The result of the analysis may include a prioritization of the alarms based on a number of factors, which will be discussed herein. By employing methods and apparatus for validating that check to see if a destination port is vulnerable to the alarm type before the alarm is reported or displayed, this process is effective to eliminate false positive alarms from the database, or, alternatively, prioritize the alarms based on levels of validation, thus reducing the number of alarms or afford prioritization to alarms needing investigation by security personnel.

It is noted here that the term “validation,” for purposes of this disclosure, may include one or more of verification of a valid alarm, distinguishing between positive and false positive alarms, and determining a prioritization of alarms such that the most “valid” or serious alarms are indicated in a priority ordering.

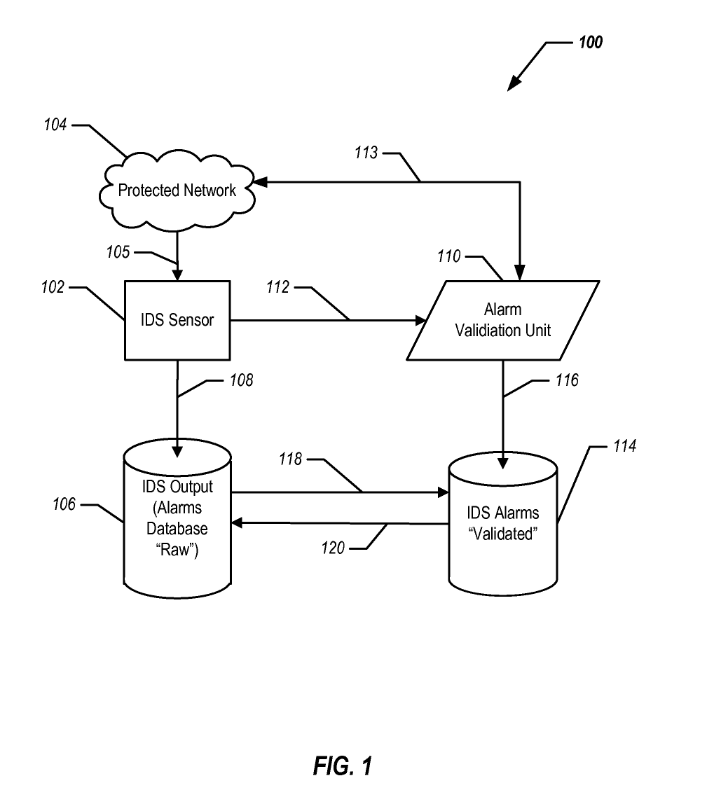

FIG. 1 illustrates a block diagram of an apparatus 100 for validating alarms in an IDS protecting a computer network. The IDS includes at least one intrusion detection system (IDS) sensor 102 communicatively coupled to a network 104 via one or more communication couplings illustrated by arrow 105. The IDS sensor 102, which is operative to fire on signature identifications based on a plurality of established signature rules (either default IDS rules, customized rules, or a combination thereof), will generate an alarm when activity being monitored on network 104 fires on a signature rule, resulting in an alarm. The alarm is then communicated to an IDS Alarm output 106 via a communication coupling 108. It is noted that output 106 may be configured as a database such as an SQL database, a flat file with a record to track and access entries, or any other suitable means to collect, collate, or store the resultant alarm output of sensor 102. Output 106 collects “Raw” alarms, meaning the alarms are not verified, but merely have triggered a rule.

Apparatus 100 also includes an alarm verification unit 110, which receives alarm information from sensor 102 as illustrated by coupling 112. In particular, the alarm information may include, but is not limited to, an alarm signature key. The alarm signature key may include a source address of the alarm, a source port of the alarm, a destination address of the alarm, and a destination port of the alarm. Additionally, in a network having two or more IDS sensors, a sensor identification may also be included within the alarm signature key. It is further noted here that the information of alarm signature key communicated to unit 110 may be the same information sensor 102 communicates to the output 106.

Moreover, it is noted that known IDS sensors may classify alarm severity based on the rule set established in the sensor. Accordingly, the classification of alarm types performed by sensor 102, for example, may be passed to validation unit 110 for use in prioritization of alarms by unit 110, as will be discussed in more detail to follow. As an example of how a sensor may be configured to classify alarm types, the classification system may include classifying some alarms a first type of alarms that will always need to be reported to security personnel, such as Worms, Trojans, Botnets, denial of service, or any other type of alarm that a user deems to by critical. A second classification of alarm types may be those less severe, but nonetheless are those known to exploit vulnerabilities particular to the network or are against policies of the network administrator. Such alarm types may include violation of policy alarms, or any other similar alarm deemed less critical than the first type of alarms. A third classification of alarms may also be utilized, which could be a catch all category for all other types of alarms. The classifications given here are merely exemplary, and further or fewer classifications of alarm types may be contemplated.

It is further noted that classification of the alarm types may be also accomplished within unit 110. In particular, the signature ID or types of the alarms passed from sensor 104 to unit 110 can be utilized to classify the alarms based on predetermined criteria implemented in unit 110.

Validation unit 110 is also configured to determine whether the destination of the alarm, and, more particularly, the specific port on the network, is vulnerable to the signature identification of the alarm by garnering port information in real time (i.e., at that current time rather than based on past port or address information) via a communication coupling with the network 104 as indicated by a representative coupling 113. Those ports that are actually vulnerable are indicated as validated or verified alarms and flagged “positive” by unit 110, and those alarms targeting ports that are not vulnerable are flagged “negative” by unit 110, based on a prescribed determination process effected by alarm verification unit 110, which will be discussed later in more detail. The positively and negatively flagged alarms are stored in a validated or verified alarm database 114, via a coupling 116.

It is noted that the verified alarms stored in database 114 include at least a portion of the alarm signature key information. Accordingly, the verified alarms in database 114 can be tied to or correlated with the unverified alarms stored in the “Raw” database or output 106 via a communication coupling or mechanism illustrated by couplings 118 and 120. Accordingly, those alarms stored at output 106 are correlated to whether the alarm is positive or negative (i.e., “false positive”). The verification unit 110 and/or the alarm database 114 may then be configured to prioritize the alarms such that the alarms may be arranged from the most pertinent or highest priority to lower priority alarms, and this information made accessible to security personnel, such as via a graphical interface (not shown). Accordingly, by affording identification of the highest priority and/or positively verified alarms stored in database 114, security analysis can be carried out effectively.

It is also noted that the apparatus 100 may be configured to report the validated alarm according to various configurations. In an exemplary configuration, the database 114 of validated alarms may simply access and modify output 106 using the alarm signature key information via a unilateral or half duplex manner communication, such as coupling 118, such that the report of validated alarms is accessible or displayed from output 106. In such an example, the need for bilateral or full duplex manner communication (i.e., coupling 120) is not necessary. In another exemplary configuration, the database 114 may communicate bilaterally or in a full duplex fashion with output 106 such that through the use of the alarm signature key information the alarms in output 106 are correlated with the validated or verified alarms in database 114, out of which the validated alarms are output or displayed for use by security personnel.

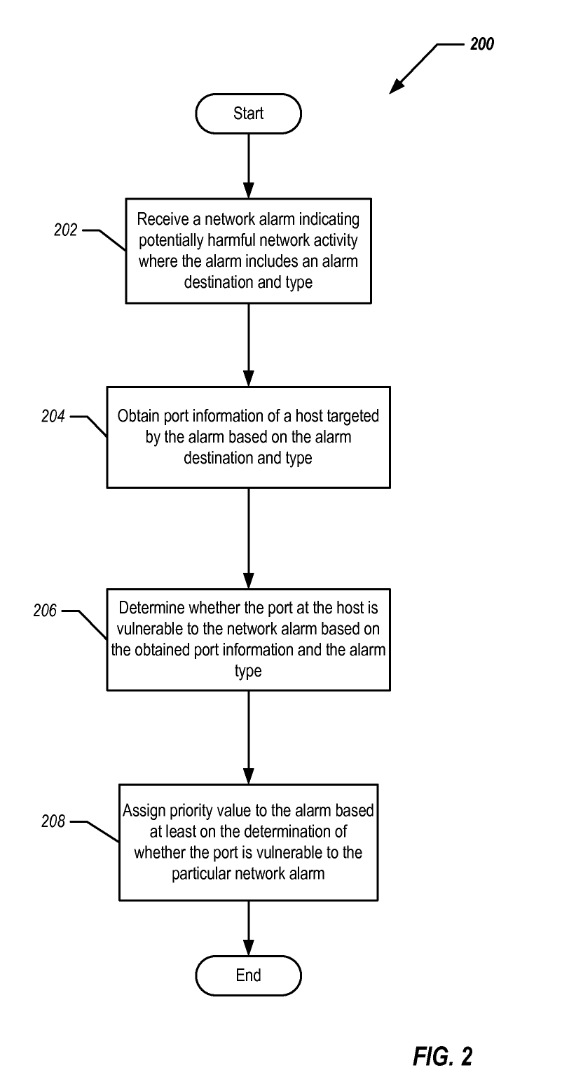

FIG. 2 illustrates a method 200 for validating network alarms in a network protection system. In a particular example, the method 200 may be effected by the apparatus 100 illustrated in FIG. 1, and by validation unit 110, in particular. As illustrated in FIG. 2, after initialization, the process 200 includes receiving a network alarm indicating potentially harmful network activity as shown in block 202. The alarm may be received from an IDS sensor, such as sensor 102 shown in FIG. 1, for example. The alarm, in particular, includes alarm signature key information, which includes one or more of the alarm type, a classification of the severity of the alarm type (as assigned by the IDS sensor), a source address of the alarm, a source port of the alarm, a destination address of the alarm, and a destination port of the alarm, as well as a sensor identification in the case of a system having a plurality of IDS sensors.

After receipt of an alarm, port information of a host targeted by the alarm is obtained based on the alarm signature key information as shown in block 204 It is noted that the term “port information” connotes various data that my be determined about the host on the network. In an example, obtaining the port information includes determining whether some program or application is running on the targeted port. Additionally, obtaining port information may further include obtaining a fingerprint of the operating system (OS) of the targeted host, a fingerprint of the OS version currently on the targeted host, a daemon of running on the port, and a daemon version of the daemon. It is noted that the process of block 204 may be effected by validation unit 110, as an example, and the information is obtained in real time over the network via a communication coupling (e.g., coupling 113 illustrated in FIG. 1).

After obtaining the port information in block 204, flow proceeds to block 206. At block 206 a determination is made whether the port at the host is vulnerable to the network alarm based on the obtained port information and the alarm type. In particular, determination of vulnerability may consist of determining whether some program or application is running on the targeted port, since if nothing is currently running on the port, the port is not vulnerable to attack. Additionally, the vulnerability determination may further consist of one or more of determining the operating system (OS) of the host of the targeted port, determining the OS version, determining the daemon running on the port, and determining the daemon version.

It is noted that mechanisms for determining the port information in block 206 may include open source utilities such as NMAP (network mapper), ACID/BASE, or any other suitable equivalent that may be used to determine port information. By obtaining further information such as the OS version, daemon, and/or daemon version, more accurate determinations of whether the alarm is valid or not can be made since each rule in an IDS is valid to a certain set of circumstances of this further information. For example, if alarmed activity indicates that wuFTP is vulnerable to the harmful activity, but the NMAP result indicates that the OS running on the destination port is a Microsoft FTP server, then alarm would not be indicative of truly harmful activity. In another example, it is noted that although a destination port may be running a vulnerable OS and OS version. However, if the port is running an Apache daemon, as an example, but the threat is only malicious to FTP, obtaining the daemon information (daemon and/or daemon version), the alarm can assessed to not be harmful. It is noted that the process of block 206 may also be implemented by validation unit 110, as an example,

After the process in block 206 is complete, flow proceeds to block 208 where a priority value is assigned to the alarm based at least on the determination of whether the port is vulnerable to the particular network alarm. This assignment may simply be determining if the alarm is a priority alarm (i.e., a valid alarm) or not (i.e., a false positive). Thus, the valid alarms may be prioritized over the false alarms. In another example, the alarms may be prioritized based on more complex factors, such as whether the alarm type is of a particular type or classification. Thus, alarms may be prioritized based on the alarm type or classification and whether the targeted port is active and vulnerable to the alarmed network activity. Process 208 may be implemented by the validation unit 110 shown in FIG. 1, as an example.

After the process of block 208 is complete, the procedure 200 ends. It is to be understood, however, that the procedure 200 is repeated for each alarm sensed by an IDS or IPA.

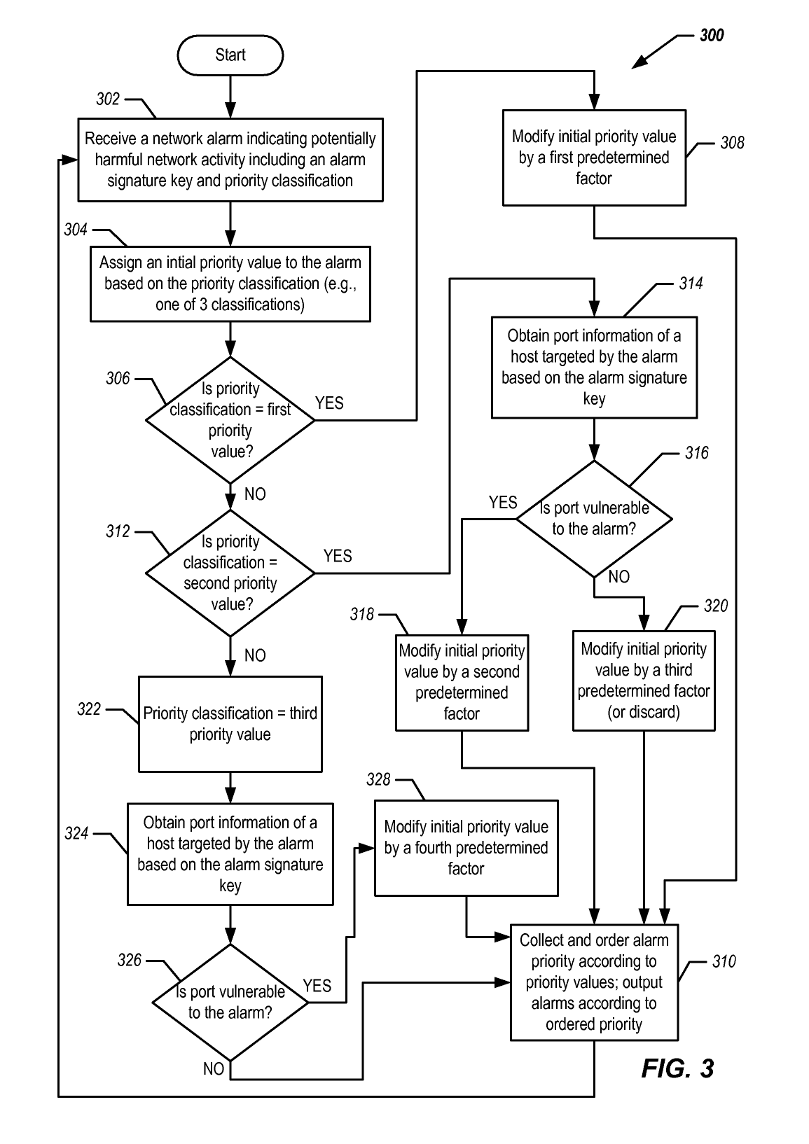

FIG. 3 illustrates another exemplary method 300 for validating alarms in a network protection system. In a particular example, the method 300 may be effected by the apparatus 100 illustrated in FIG. 1, and by validation unit 110, in particular. It is noted once again here that sensors employed in IDS systems may include the functionality of being able to classify alarm types based on predetermined rules and rule sets. For example, alarms may be classified into at least two different categories based on type or severity. As a specific example, alarms could be classified into three classification priorities—1) alarms that should always be reported to security personnel, such as worm or Trojans; 2) alarms that are special to the particular network environment (e.g., known vulnerabilities to these threats are extant) and/or are against policies of the network administrator; and 3) all other alarms types. Accordingly, the present method, as implemented by a unit 110, for example, may then include receipt of a network alarm indicating potentially harmful network activity from an IDS sensor (e.g., sensor 102 in FIG. 1), where the alarm includes an alarm signature key and the priority classification as indicated by block 302 in method 300.

After receipt of the alarms in block 302, the alarm type may be assigned, scored, or flagged with a priority number or value as indicated by block 304. Merely for purposes of example, the priority values or scores could be 1, 2 and 3, for alarms always reported, alarms special to the network, and all other alarms, respectfully, using the example from above. It is noted that the process of blocks 302 and 304 may be effected by unit 110 shown in FIG. 1.

After priority values are assigned to the different alarm types in block 304, flow proceeds to decision block 306 where a determination is made whether the priority value is of a first priority value. Using the example above, the first priority value could be 1, signifying an alarm type that is desired to always be seen. Accordingly, as the flow proceeds from decision block 306 to block 308 upon a determination that the alarm was assigned the first priority value, the initial priority value is modified by a first predetermined factor. As an example, if the priority number is 1, the priority number may be modified by a first predetermined factor of 10, thus resulting in a modified priority value of 10 (1×10). After modification of the value in block 308, flow would then proceed to block 310 where the alarm priority value is collected and ordered according to the particular priority value. Additionally, the alarm may be correlated to the raw alarm data, as was explained previously with respect to FIG. 1. The alarm is also output to some reporting media, such as a printer or a display. Flow may also proceed back to block 302 for reception of the next or subsequent alarm.

If, at decision block 306, the alarm is not of the first priority classification, flow alternatively proceeds to decision block 312 where a determination is made whether the alarm has been assigned a second priority value. If the alarm is assigned the second priority value, port information of the host targeted by the alarmed threat is obtained as illustrated by block 314 based on at least a portion of the alarm signature key information. This port information may then be utilized to determine if the port is vulnerable to the threat triggering the alarm, as shown by decision block 316. As an example, an NMAP operation on the destination IP and port may be run, such as by unit 110 via connection 113, to determine if the destination is indeed running some program or application on the destination port. If the port is vulnerable, as may be determined by at least one of the port being currently active and the particular port features (e.g., OS, OS version, daemon, and daemon version), flow proceeds to block 318.

At block 318, the initial priority value is modified by a second predetermined factor.

Continuing the example given above, if the initial second priority value is set at 2, such as for alarms presenting some particular threat or vulnerability to the protected network, the priority value may be modified or changed by a factor of 15 times (now 2×15=30). Thus, according to this example, the priority of these alarms would have a higher value than the alarms classified with the initial priority value of 1. Flow then proceeds to block 310 for collection and ordering of the alarms according to the priority value.

Alternatively at block 316, if the port is not vulnerable to the alarm, such as when the port is not running anything on destination port or the checks of the OS, OS version, daemon, and daemon version reveal that the port is not vulnerable to the threat, the priority value may be changed or modified by a third predetermined factor as shown in block 320. It is noted that the third predetermined factor will have a value less than the second predetermined factor since the alarm is not threatening or harmful to port (i.e., an identified “false positive”). In the example above, the initial priority value could be modified by a factor of 5, resulting in a priority value of 10 (2×5). It is noted that the change or modification of the priority value in block 320 is accomplished when it is nonetheless desirable for security personnel to have notice of even false positives for certain classifications of alarms. As an alternative at block 320, the alarm could simply be discarded rather than modifying the priority value. After the process of block 320 is complete, flow proceeds to block 310.

If the priority classification is not the second priority value, as determined at decision block 312, flow instead proceeds to block 322. In the present example, it is assumed that only three classifications of priority exist, thus block 322 is simply shown as confirmation that the priority is equal to a third priority value since the priority is neither the first and second priority values. It is further noted that the determination of whether an alarm is of the first, second, or third priority classifications may be accomplished as a single process, rather than the represented decision blocks 306, 312 and 322.

After block 322, flow proceeds to block 324 where port information of the host targeted by the alarmed threat is obtained based on at least a portion of the alarm signature key information. After the port information is obtained, a determination is made whether the port is vulnerable to the alarm, such as through an NMAP of the port as discussed previously, for example. If the port is not vulnerable, the initial priority value of the alarm is left unchanged (e.g., 3 as given in the example above) and flow simply proceeds to block 310 for collection and ordering of alarms based on priority. Alternatively, the alarm may also be discarded since the port was determined to not be vulnerable (i.e., a “false positive”).

If the port is vulnerable as determined a block 326, flow proceeds to block 328 where the initial priority value is modified by a fourth predetermined factor. Again continuing the example from above, if the third priority value is 3, then the fourth predetermined factor may be selected to ensure that a highest priority value is assigned to alarmed threats determined to be harmful to the destination port. For example, the priority value of 3 may be changed or modified by a fourth predetermined factor of 10 times, which results in a priority value of 30 (3×10). After modification of the priority value in block 328, flow proceeds to block 310 for collection and ordering of the alarms according to their priority values. It is noted that the process of block 310 may select and join tables in a database server, for example, at may be further configured to output, such as by display or print, alarms in order of their priority values. In a further example, the process may configured to only output alarms having a priority set greater than or equal to a predetermined value, such as 10 in the specific example given above.

It is noted that the methods 200 and 300 discussed above represent just two different implementations and changes, additions, deletions, combinations or other modifications of the methods 200 or 300 are possible within the scope of the present disclosure. Although for purposes of simplicity of explanation, the methods of FIGS. 2 and 3 are shown and described as a series or number of acts, it is to be understood that the processes described herein are not limited by the order of acts, as some acts may occur in different orders and/or concurrently with other acts from that shown and described herein. For example, as mentioned previously the functionalities of decision blocks 306 and 312, as well as the determination in block 322 may be carried out as one determination decided whether the alarm type is of a first, second, or third classification based on the classification value. As another example, those skilled in the art will appreciate that a methodology could alternatively be represented as a series of interrelated states or events, such as in a state diagram. Moreover, not all illustrated acts may be required to implement a method in accordance with the present exemplary methods disclosed.

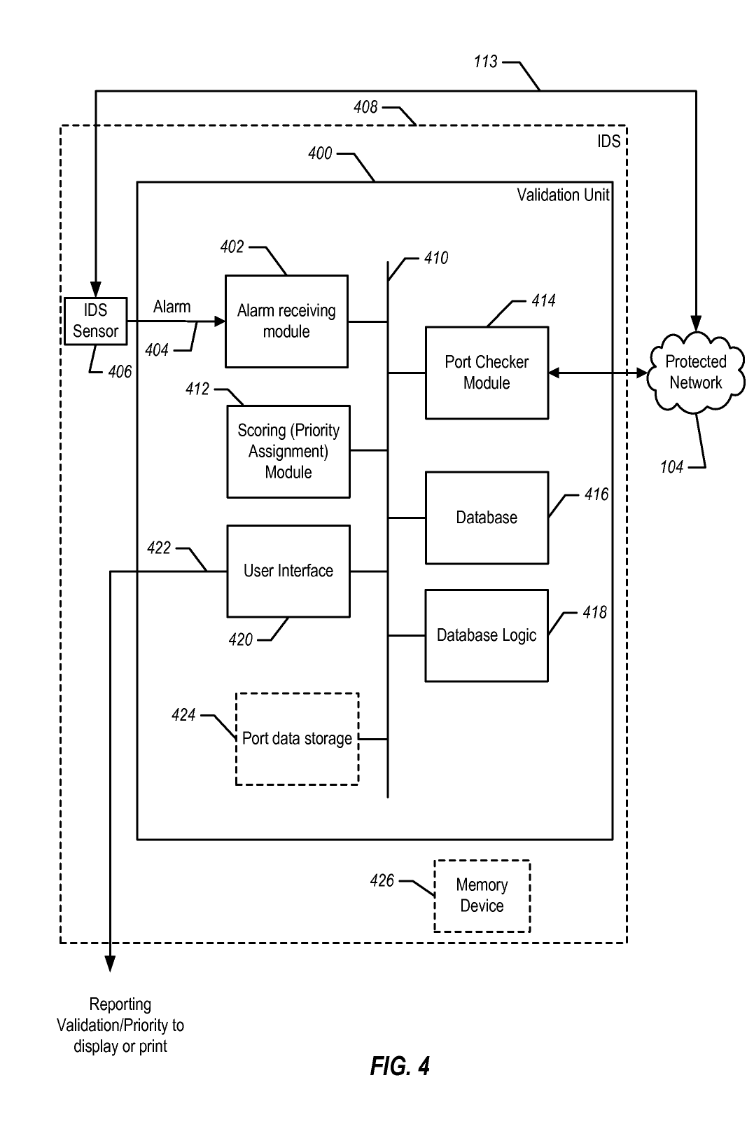

FIG. 4 illustrates an example of an apparatus for use with, or integrated within an IDS system, or alternatively an IDS system. The apparatus includes a validation unit 400, which is similar to unit 110 illustrated in FIG. 1 in terms of functionality. The validation unit receives alarms 404 from an IDS sensor 406 monitoring the protected network 104.

The sensor 406 is part of an IDS system 408, which may also incorporate validation unit 400, either as an integral part or as an added unit. The alarms 404 include the alarm signature key, discussed previously, as well as alarm type classification (which may be part of the alarm signature key). Examples of functions that may be effected by module 402, include the processes of blocks 202 or 302 in FIGS. 2 and 3, respectively. The alarm receiving module 402 is communicatively coupled to a communication bus 410, or any other suitable device or means for effecting communication of data and information. It is noted that communication bus 410 also represents that all modules within the unit 400 may effectively communicate needed information therebetween.

Receiving module 402 transmits the received alarm information to a scoring or priority assignment module 412 via a communication bus 410. The scoring module 412 utilizes the alarm classification information obtained from sensor 406 to assign an initial priority value to alarm. Taking the example of FIG. 3, the function of block 304 may be implemented by module 412. Additionally, the scoring module 412 may be configured to further modify the initial priority values based on the priority value itself (e.g., processes of blocks 306 and 308 in FIG. 3 or process of block 208 in FIG. 2), or further based on whether a targeted port is vulnerable to the alarmed threat (e.g., processes of blocks 312, 318, 320, 322, and 328 of FIG. 3 or process of block 208 in FIG. 2).

Unit 400 further includes a port checker module 414, which is communicatively coupled to the protected network 104. Module 414 is configured to check whether a port targeted by an alarmed potential threat is running some program or application, as well as determine other port information based on the signature key information. For example, the checker module 414 is used to determine one or more of the operating system (OS), the OS version, the daemon, and the daemon version. The processes of blocks 206, 314, or 324 in the methods of FIGS. 2 and 3 may be effected by module 414, as an example.

Further included in unit 400 are a database 416 and accompanying database logic 418. The database 416,which may be an SQL database or any other suitable means of storing and organizing data, is used, among other things, to store information related to alarm types, known vulnerability data of network ports to the alarm types, and correspondence information used to link alarms to another database, such as output or Raw alarm database 106, either to modify output 106, or to report alarms from unit 400, which are tied or correlated to the raw alarms in output 106. Additionally, database 416 in conjunction with logic 418 are used to collate alarms from the scoring module 412 and arrange the alarms based on the final priority values assigned to the alarms. Furthermore, the database 416 and logic 418 may also be configured to discard alarms determined to be “false positives” as decided by either module 412 or 414, or a combination thereof. These functionalities were discussed previously in connection with the processes of blocks 208, 310 and/or 320, as examples.

The prioritized alarms from database 416 may be then output via a user interface 420 to an output 422. Output 422 may be in the form of a printout or a display to report validation (either as prioritized alarms or prioritized alarms with false positive culled from the reported alarms) to security personnel. The display may further include presentation on a screen with a graphical user interface (GUI).

An additional feature of the unit 400 may include a port data storage 424, which is used to store alarm types of the received detected network alarm and the resultant obtained port information obtained by the port checker module 414. With module 414, a heuristic may be effected to afford optimization of the validation function of unit 400. In particular, the stored port information of a port checked by module 414 may be used to determine whether subsequently received alarms where a rule fires against the same alarm destination have characteristics similar to the alarm destination and alarm stored in storage 424. If so, the port checker 414 may be relieved of obtaining port information for subsequent similarly addressed alarms, since the validation (e.g., vulnerability or the acceptability of the risk) is already known. Accordingly, based on this data, the scoring module 412, for example, may simply assign a priority value to the alarm without obtaining port information. This priority value could represent either a “false positive” or an increase in the priority value of the alarm. Further, the storage duration in storage 424 may also be prescribed to a particular time period since port and IP address information is not a static in typical networks, necessitating periodic updating of the port information by checker module 414. Moreover, storage 424 affords a user of unit 400 the ability to assign different vulnerability states or values to particular alarm types, as well as customization of rules within the unit 400 that may diverge with the rule set in the sensor 406.

As described above, the present methods and apparatus afford an output prioritized reporting of alarms. Thus, when the alarms are displayed or printed for viewing and are sorted by priority in a descending order, for example, the highest priority alarm(s) will be easily identified to security personnel to work on the alarms in order of priority. Additionally, identified false positives may further be discarded and not displayed. Accordingly, the presently disclosed apparatus and methods effect a reduction in false alarms reported to security personnel, and afford an automated way to prioritize the presented to security personnel. As an example of the degree to which the presently disclosed validation may reduce the number of alarms reported in a system having a daily alarm count of 400,000 alarms, for example, the presently disclosed apparatus and methods output a validated 14,800 alarms from the daily count, which is a 96.3% reduction from a conventional IDS system, with a tested accuracy of 99.89%.

Those skilled in the art will further appreciate that the various illustrative logical blocks, modules, units, and algorithmic processes described in connection with the examples disclosed herein may be implemented as electronic hardware, computer software, firmware, or combinations thereof. To clearly illustrate this interchangeability of hardware and software, various illustrative components, blocks, modules, units, and processes have been described above generally in terms of their functionality. Whether such functionality is implemented as hardware or software depends upon the particular application and design constraints imposed on the overall system. Those skilled in art may implement the described functionalities in varying ways for each particular application, but such implementation decisions should not be interpreted as causing a departure from the scope of the present disclosure. Also, the disclosed apparatus may be implemented as either modules or logic added to an existing IDS, or may be integral to an “off the shelf” IDS system. Additionally, the presently disclosed methods and apparatus may be implemented at least in part by software or firmware that is either added to an existing IDS system, or alternatively made integral with an “off the shelf” IDS.

Additionally the disclosed methods and algorithmic processes may be implemented by a computer program product (i.e., software) that can be stored on a computer readable or storage medium, such as a memory device (426 shown in FIG. 4, as an example). The storage medium or memory device may include, but is not limited to, RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor or computer, which executes the computer program product.

The examples described above are merely exemplary and those skilled in the art may now make numerous uses of, and departures from, the above-described examples without departing from the inventive concepts disclosed herein. Various modifications to these examples may be readily apparent to those skilled in the art, and the generic principles defined herein may be applied to other examples, without departing from the spirit or scope of the novel aspects described herein. Thus, the scope of the disclosure is not intended to be limited to the examples shown herein but is to be accorded the widest scope consistent with the principles and novel features disclosed herein. It is noted that the word “exemplary” is used exclusively herein to mean “serving as an example, instance, or illustration.” Any example described herein as “exemplary” is not necessarily to be construed as preferred or advantageous over other examples. Accordingly, the novel aspects described herein are to be defined solely by the scope of the following claims.

What is claimed is:

1. A method for validating network alarms detected on a network, comprising:
receiving a detected network alarm indicating potentially harmful network activity, the alarm including an alarm destination and an alarm type;
obtaining port information of a host targeted by the alarm based on the alarm destination and alarm type;
determining whether the port at the host is vulnerable to the network alarm based on the obtained port information and the alarm type; and
assigning a priority value to the alarm based at least on the determination of whether the port is vulnerable to the particular network alarm in order to assess validity of the network alarm.

2. The method as defined in claim 1, wherein obtaining port information comprises:
determining if a targeted port at the alarm destination is currently active; and
determining one or more of an operating system type of a targeted host, an operating system version of the operating system type, a daemon type running on the targeted port, and a version of the daemon type.

3. The method as defined in claim 2, wherein determining whether the port at the host is vulnerable to the network alarm is based at least on a determination that the targeted port at the alarm destination is currently active.

4. The method as defined in claim 1, wherein assigning the priority value comprises:
assigning one of a plurality of priority values to the alarm based on predetermined priority criteria based on alarm types; and
modifying a first priority value of the alarm by a first factor if the alarm is a first predetermined priority.

5. The method as defined in claim 1, further comprising:
determining whether an alarm type of the received detected network alarm is at least one of a first and a second predetermined type of alarm.

6. The method as defined in claim 5, further comprising:
assigning a first priority value to the alarm without obtaining port information of the host targeted by the alarm and without determining whether the port at the host is vulnerable to the network alarm when the alarm type is the first predetermined type of alarm.

7. The method as defined in claim 5, further comprising:
assigning a second priority value to the alarm when the alarm type is the second predetermined type of alarm;
modifying the second priority value by a predetermined factor when the port at the host is determined to be vulnerable to the network alarm.

8. The method as defined in claim 1, further comprising:
storing an alarm type of the received detected network alarm and the obtained port information;
determining whether a subsequently received alarm has a corresponding further alarm destination with characteristics similar to the alarm destination; and
assigning a priority value to the alarm without obtaining port information when the characteristics of the further alarm destination are determined to be similar to the alarm destination.

9. A computer program product, comprising:
computer-readable medium comprising:
code for causing a computer to receive a detected network alarm indicating potentially harmful network activity, the alarm including an alarm destination and an alarm type;
code for causing a computer to obtain port information of a host targeted by the alarm based on the alarm destination and alarm type;
code for causing a computer to determine whether the port at the host is vulnerable to the network alarm based on the obtained port information and the alarm type; and
code for causing a computer to assign a priority value to the alarm based at least on the determination of whether the port is vulnerable to the particular network alarm in order to assess validity of the network alarm.

10. The computer program product as defined in claim 9, wherein the code for obtaining port information further comprises:
code for causing a computer to determine if a targeted port at the alarm destination is currently active; and
code for causing a computer to determine one or more of an operating system type of a targeted host, an operating system version of the operating system type, a daemon type running on the targeted port, and a version of the daemon type.

11. The computer program product as defined in claim 10, wherein the determination whether the port at the host is vulnerable to the network alarm is based at least on a determination that the targeted port at the alarm destination is currently active.

12. The computer program product as defined in claim 9, wherein the code for causing a computer to assign the priority value further comprises:
code for causing a computer to assign one of a plurality of priority values to the alarm based on predetermined priority criteria based on alarm types; and
code for causing a computer to modify a first priority value of the alarm by a first factor if the alarm is a first predetermined priority.

13. The computer program product as defined in claim 9, wherein the computer-readable medium further comprises:
code for causing a computer to determine whether an alarm type of the received detected network alarm is at least one of a first and a second predetermined type of alarm.

14. The computer program product as defined in claim 13, wherein the computer-readable medium further comprises:
code for causing a computer to assign a first priority value to the alarm without obtaining port information of the host targeted by the alarm and without determining whether the port at the host is vulnerable to the network alarm when the alarm type is the first predetermined type of alarm.

15. The computer program product as defined in claim 13, wherein the computer-readable medium comprising further comprises:
code for causing a computer to assign a second priority value to the alarm when the alarm type is the second predetermined type of alarm;
code for causing a computer to modify the second priority value by a predetermined factor when the port at the host is determined to be vulnerable to the network alarm.

16. The computer program product as defined in claim 9, wherein the computer-readable medium further comprises:
code for causing a computer to store an alarm type of the received detected network alarm and the obtained port information;
code for causing a computer to determine whether a subsequently received alarm has a corresponding further alarm destination with characteristics similar to the alarm destination; and
code for causing a computer to assign a priority value to the alarm without obtaining port information when the characteristics of the further alarm destination are determined to be similar to the alarm destination.

17. An apparatus for use with an intrusion detection system comprising:
a receiving module configured to receive a detected network alarm from at least one intrusion detection sensor a detected network alarm indicating potentially harmful network activity, the alarm including an alarm destination and an alarm type;
a port checking module configured to obtain port information of a host targeted by the alarm based on the alarm destination and alarm type and determine whether the port at the host is vulnerable to the network alarm based on the obtained port information and the alarm type; and
a scoring module configured to assign a priority value to the alarm based at least on the determination of whether the port is vulnerable to the particular network alarm in order to assess validity of the network alarm.

18. The apparatus as defined in claim 17, wherein the port checker module is further configured to determine if a targeted port at the alarm destination is currently active; and to determine one or more of an operating system type of a targeted host, an operating system version of the operating system type, a daemon type running on the targeted port, and a version of the daemon type.

19. The apparatus as defined in claim 18, wherein the port checker module is configured to determine whether the port at the host is vulnerable to the network alarm is based at least on a determination that the targeted port at the alarm destination is currently active.

20. The apparatus as defined in claim 17, wherein the scoring module is further configured to assign one of a plurality of priority values to the alarm based on predetermined priority criteria based on alarm types, and modify a first priority value to the alarm by a first factor if the alarm is a first predetermined priority.

21. The apparatus as defined in claim 17, wherein the scoring module is further configured to determine whether an alarm type of the received detected network alarm is at least one of a first and a second predetermined type of alarm.

22. The apparatus as defined in claim 21, wherein the scoring module is further configured to assign a first priority value to the alarm without obtaining port information of the host targeted by the alarm and without using information concerning whether the port at the host is vulnerable to the network alarm when the alarm type is the first predetermined type of alarm.

23. The apparatus as defined in claim 6, further comprising:
assigning a second priority value to the alarm when the alarm type is the second predetermined type of alarm;
modifying the second priority value by a predetermined factor when the port at the host is determined to be vulnerable to the network alarm.

24. The apparatus as defined in claim 17, further comprising:
a port data storage configured to store an alarm type of the received detected network alarm and the obtained port information, and determine whether a subsequently received alarm has a corresponding further alarm destination with characteristics similar to the alarm destination; and
the scoring module configured to assign a priority value to the alarm without port information when the port data storage determines that characteristics of the further alarm destination are similar to the alarm destination.

25. An intrusion detection system comprising:
a sensor configured to sense potentially harmful activity on a network and to indicate an alarm when the potentially harmful activity is sensed; and
a validation unit configured to validate whether the alarm is a valid alarm, the validation unit including:
a receiving module configured to receive a detected network alarm from at least one intrusion detection sensor a detected network alarm indicating potentially harmful network activity, the alarm including an alarm destination and an alarm type;
a port checking module configured to obtain port information of a host targeted by the alarm based on the alarm destination and alarm type and determine whether the port at the host is vulnerable to the network alarm based on the obtained port information and the alarm type; and
a scoring module configured to assign a priority value to the alarm based at least on the determination of whether the port is vulnerable to the particular network alarm in order to assess validity of the network alarm.
